(19) United States
(12) Patent Application Publication
(10) Pub. No.: US 2018/0075392 A1
(43) Pub. Date: Mar. 15, 2018

(54) STANDARDIZED ATHLETIC EVALUATION SYSTEM AND METHODS FOR USING THE SAME

(71) Applicant: Real Time Athletes, Inc., Newbury Park, CA (US)

(72) Inventor: Robert Surane, Newbury Park, CA (US)

(21) Appl. No.: 15/701,972

(22) Filed: Sep. 12, 2017

Related U.S. Application Data
(60) Provisional application No. 62/393,176, filed on Sep. 12, 2016.

(51) Int. Cl. G06Q 10/06; G06F 17/30

(52) U.S. Cl. CPC G06Q 10/06393; G06Q 20/26; G06F 17/30864

(57) ABSTRACT

A method, apparatus, and computer program product for a standardized athletic rating system. The system is configured to receive a request to display at least one user profile associated with an event, perform a query to locate the at least one user profile associated with the event, and present the at least one user profile for display. The system is further configured to receive a request to enter at least one first set of user data to be associated with the user. The system is further configured to receive at least one second set of user data to be associated with the user profile, and determine a rating based on the at least one first set of user data and the at least one second set of user data. The rating may then be utilized to compare the user profile against other user profiles.

### CROSS REFERENCE TO RELATED APPLICATIONS

This patent application claims priority from U.S. Provisional Application No. 62/393,176, filed Sep. 12, 2016, entitled “Athletic Rating System,” which is hereby incorporated by reference in its entirety.

### TECHNOLOGICAL FIELD

Example embodiments of the present invention relate generally to computer technology and, more particularly, relate to methods, apparatuses, and computer program products for rating an athlete's athletic abilities and skills. More specifically, the present invention is an athlete rating system that enables an athlete to be rated based on his or her athletic abilities as well as on independent ratings for specific skill areas.

### BACKGROUND

Athletic scouting is a key aspect of competitive sports, and in particular, at the college and professional level. The scouting process generally involves the observation of a player in a game environment during which a scout is able to evaluate the player's athletic abilities and skills. Scout evaluations are often used at the college level when attempting to recruit high school players to specific collegiate programs. Similarly, scout evaluations are used at the professional level to evaluate high school and college players who may be drafted to the professional level. Scouts are often tasked with not only evaluating a player's athletic abilities and physical skill set, but also with projecting the player's potential to perform at a higher level as well the player's potential career longevity.

Geographic diversity of athletic recruits may make in-person scouting costly and time consuming, and individual teams may not have the opportunity to personally view all athletic recruits that may potentially be well suited to their program. While individual teams may have access to some information about potential recruits, such as playing statistics, the available information may not be suitable for comparing different potential recruits to one another. For example, a potential recruit with relatively desirable playing statistics in a low competition environment may not be readily compared another recruit with comparatively worse playing statistics in a high competition environment.

A need exists for a system that allows potential recruits to be readily compared to one another by standardized metrics.

### BRIEF SUMMARY

Current ways of assessing an athlete's athletic abilities lack the sophistication desired by talent evaluators and, therefore, may have difficulty capturing an athlete's athletic performance adequately and in real-time, forcing them to filter through numerous athletes' profiles and evaluations to enter data. Along these lines, a talent evaluator may not easily assess an athlete's athletic potential or in comparison with other athletes. Furthermore, communized evaluation techniques may not be utilized, making comparisons between potential recruits difficult.

Methods, apparatuses, and computer program products are provided herein for an athlete rating system that enables an athlete to be rated based on his or her athletic abilities. The present invention additionally enables an athlete to be independently rated by multiple scouts and talent evaluators. In one embodiment of the present invention, an athlete's athletic abilities in his or her sport are rated through a series of tests that are specific to the athlete's sport. An Athletic Index that serves as a measure of the athlete's athletic abilities is calculated based on the results of these tests. The athlete is then rated by a minimum of three independent professional scouts. The athlete is tested on a defined set of skills that are specific to his or her sport. Athlete testing is standardized and all athletes are assessed based on the exact same criteria. The ratings provided by the scouts are then averaged in order to calculate a Skill Index that serves as a measure of the athlete's skills in the specific sport. The Athletic Index and the Skill Index are then combined in order to calculate a Total Player Rating that serves as an overall athlete rating taking into account the athlete's athletic abilities and the athlete's skills specific to his or her sport.

In an example embodiment, a method includes receiving a request to display at least one user profile associated with an event, performing a query to locate the at least one user profile associated with the event, presenting for display via a user terminal, the at least one user profile, receiving a request to enter at least one first set of user data to be associated with the user, determining, based at least in part on the at least one user profile, at least one test, presenting for display via the user terminal, the at least one test, receiving the at least one first set of user data to be associated with the at least one user profile, where the at least one first set of user data is associated with the at least one test, receiving at least one second set of user data to be associated with the user profile, and determining a rating based on the at least one first set of user data and the at least one second set of user data.

In another embodiment, an apparatus includes at least one processor and at least one non-transitory memory including computer program code, the at least one non-transitory memory and the computer program code configured to, with the at least one processor, cause the apparatus at least to, receive a request to display at least one user profile associated with an event, perform a query to locate the at least one user profile associated with the event, present for display via a user terminal, the at least one user profile, receive a request to enter at least one first set of user data to be associated with the user, determine, based at least in part on the at least one user profile, at least one test, present for display via the user terminal, the at least one test, receive the at least one first set of user data to be associated with the at least one user profile, where the at least one first set of user data is associated with the at least one test, receive at least one second set of user data to be associated with the user profile, and determine a rating based on the at least one first set of user data and the at least one second set of user data.

In yet another embodiment, a computer program product including a non-transitory computer readable medium has program code portions means stored thereon, the program code portions being a computer readable medium and configured when said program product is run on a computer or network device, to receive a request to display at least one user profile associated with an event, perform a query to locate the at least one user profile associated with the event, present for display via a user terminal, the at least one user profile, receive a request to enter at least one first set of user data to be associated with the user, determine, based at least in part on the at least one user profile, at least one test, present for display via the user terminal, the at least one test, receive the at least one first set of user data to be associated with the at least one user profile, where the at least one first set of user data is associated with the at least one test, receive at least one second set of user data to be associated with the user profile, and determine a rating based on the at least one first set of user data and the at least one second set of user data.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIG. 1 illustrates a system for athletic skill evaluation system, according to some example embodiments described herein;

FIG. 2 illustrates a block diagram of an athlete evaluation apparatus, according to some example embodiments described herein;

FIG. 3 illustrates an exemplary display of a listing sporting events, according to some example embodiments described herein;

FIG. 4 illustrates an exemplary display of an athlete roster for a sporting event, according to some example embodiments described herein;

FIGS. 5a and 5b illustrates exemplary displays of an athlete profile, according to an example embodiment described herein;

FIG. 6 illustrates an exemplary display of an athlete registration, according to some example embodiments described herein;

FIG. 7 illustrates an exemplary display of an existing athlete registration, according to some example embodiments described herein;

FIGS. 8a-8h illustrate exemplary interactive displays allowing a user to enter scores for an athlete's performance, according to some example embodiments described herein;

FIGS. 9a-9g illustrates exemplary interactive displays allowing a user to evaluate and rate an athlete's performance, according to some example embodiments described herein;

FIG. 10 illustrates an exemplary display of an athlete evaluation, according to some example embodiments described herein;

FIG. 11 illustrates an exemplary display of an athlete's profile, according to some example embodiments described herein;

FIGS. 12a and 12b illustrates exemplary displays of an athlete's evaluation, according to some example embodiments described herein;

FIGS. 13a and 13b illustrates exemplary displays of additional views of an athlete's evaluation, according to some example embodiments described herein;

FIGS. 14a and 14b illustrates exemplary displays of additional views of an athlete's evaluation, according to some example embodiments described herein;

FIG. 15 is a flowchart illustrating an example method for registering an athlete, according to some example embodiments described herein; and

FIG. 16 is a flowchart illustrating an example method for entering evaluation scores, according to some example embodiments described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable storage media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As used herein, where a computing device is described herein to receive data from another computing device, it will be appreciated that the data may be received directly from the another computing device and/or may be received indirectly via one or more intermediary computing devices, such as, for example, one or more servers, relays, routers, network access points, and/or the like. Similarly, where a computing device is described herein to send data to another computing device, it will be appreciated that the data may be sent directly to the another computing device or may be sent to another computing device via one or more interlinking computing devices, such as, for example, one or more servers, relays, routers, network access points, and/or the like.

Additionally, as used herein, although the figures and examples may refer to users such as talent evaluators, scouts, and players, other types of users are contemplated (e.g., coaches, educators, employers, contractors, consultants, etc.). Indeed, example embodiments of the present invention may be used with any type of user.

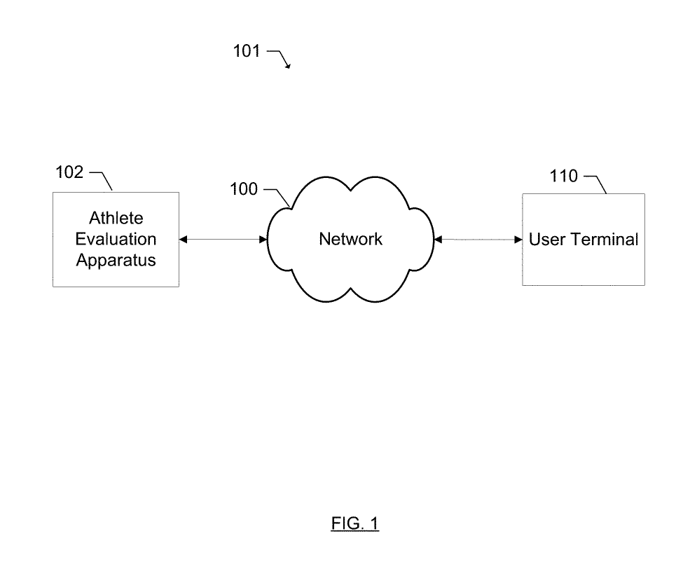

FIG. 1 illustrates a system 101 for athletic performance rating and assessment system according to some example embodiments. It will be appreciated that the system 101 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for athletic performance rating and assessment, numerous other configurations may also be used to implement embodiments of the present invention.

The system 101 includes an athlete evaluation apparatus 102 that is configured to provide athletic performance rating and assessment to any number of user terminals 110, which may, for example, be embodied as a laptop computer, tablet computer, mobile phone, desktop computer, workstation, or other like computing device. In some embodiments, a user terminal 110 may be remote from the athlete evaluation apparatus 102, in which case the user terminal 110 may communicate with the athlete evaluation apparatus 102 remotely, such as via network 100. Additionally or alternatively, the user terminal 110 may be implemented on the athlete evaluation apparatus 102 or may be directly connected to the athlete evaluation apparatus 102.

Athlete evaluation apparatus 102 is configured to communicate with user terminal 110 via any of a variety of methods dependent upon the configuration of the system 101. For example, in embodiments in which the athlete evaluation apparatus 102 is disposed remotely from the user terminal 110, communication via the network 100 may occur by a variety of connections. The network 100 may be embodied in a local area network, the Internet, any other form of a network, or in any combination thereof, including proprietary private and semi-private networks and public networks. The network 100 may comprise a wireline network, wireless network (e.g., a cellular network, wireless local area network, a wireless wide area network, some combination thereof, or the like), or a combination thereof, and in some example embodiments comprises at least a portion of the Internet.

In some example embodiments, the athlete evaluation apparatus 102 may be embodied as one or more computing devices, such as, by way of non-limiting example, one or more servers configured to access the network 100. In some example embodiments, the athlete evaluation apparatus 102 may be implemented as a distributed system or a cloud-based entity that may be implemented within the network 100. In this regard, the athlete evaluation apparatus 102 may comprise one or more servers, a server cluster, one or more network nodes, a cloud computing infrastructure, some combination thereof, or the like.

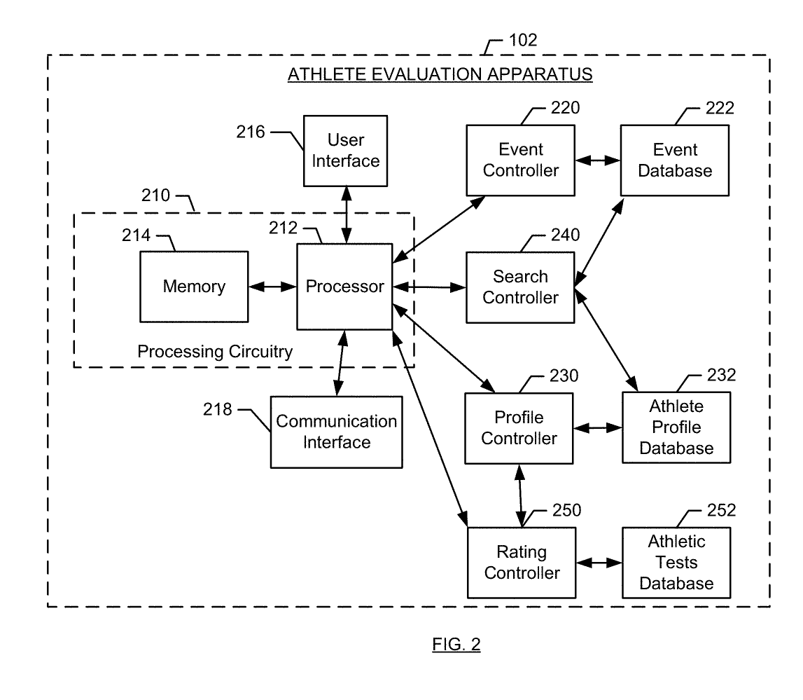

FIG. 2 illustrates the athlete evaluation apparatus 102 in further detail, in accordance with some example embodiments. However, it should be noted that the components, devices, and elements illustrated in and described with respect to FIG. 2 may not be mandatory and, thus, on or more of the components, devices, or elements illustrated may be omitted in certain embodiments. Additionally, some embodiments may include further or different components, devices, or elements beyond those illustrated in and described with respect to FIG. 2.

Continuing with FIG. 2, processing circuitry 210 may be provided that is configured to perform actions in accordance with one or more example embodiments disclosed herein. In this regard, the processing circuitry 210 may be configured to perform and/or control performance of one or more functionalities of the athlete evaluation apparatus 102 in accordance with various example embodiments. The processing circuitry 210 may be configured to perform data processing, application execution, and/or other processing and management services according to one or more example embodiments. In some embodiments, the athlete evaluation apparatus 102 or a portion(s) or component(s) thereof, such as the processing circuitry 210, may be embodied as or comprise a circuit chip. The circuit chip may be configured to perform one or more operations for providing the functionalities described herein.

In some example embodiments, the processing circuitry 210 may include a processor 212 and, in some embodiments such as that illustrated in FIG. 2, may further include memory 214. The processing circuitry 210 may be in communication with or otherwise control any number of components or controllers configured to perform various operations consistent with some embodiments of the present invention. For example, with reference to FIG. 2, the processing circuitry 210 may be in communication with or otherwise control (e.g., via the processor 212) a user interface 216, an event controller 220, profile controller 230, search controller 240, rating controller 250, and/or a communication interface 218. In some embodiments, the processing circuitry 210 may be embodied as a circuit chip (e.g., an integrated circuit chip) configured (e.g., with hardware, software, or a combination of hardware and software) to perform operations described herein. Along these lines, though the illustrated example embodiment of FIG. 2 details a number of different controllers and/or components in communication with or otherwise controlled by the processing circuitry 210, in some embodiments the processing circuitry 210 may be configured to directly control any operation described herein.

The processor 212 may be embodied in a number of different ways. For example, the processor 212 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the athlete evaluation apparatus 102 as described herein. The plurality of processors may be embodied on a single computing device or distributed across a plurality of computing devices collectively configured to function as the athlete evaluation apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry in the form of processing circuitry 210) capable of performing operations according to embodiments of the present invention while configured accordingly. Thus, for example, when the processor 212 is embodied as an ASIC, FPGA, or the like, the processor 212 may comprise hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the athlete evaluation apparatus 102. The memory 214 may be configured to store information, data, applications, instructions and/or the like for enabling the athlete evaluation apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents, or data sets. Among the contents of the memory 214, applications may be stored for execution by the processor 212 to carry out the functionality associated with each respective application. Specifically, the memory 214 may have stored thereon the athlete evaluation application (or “app”) that, upon execution, configures the athlete evaluation apparatus 102 embodied by (in some embodiments), or associated with user terminal 110, to provide the functionality described herein. In some cases, the memory 214 may be in communication with one or more of the processor 212, user interface 216, communication interface 218, event controller 220, profile controller 230, search controller 240, and rating controller 250 for passing information among components of athlete evaluation apparatus 102.

The user interface 216 may be in communication with the processing circuitry 210 to receive an indication of a user input at the user interface 216 and/or to provide an audible, visual, mechanical, or other output to the user. As such, the user interface 216 may include, for example, a keyboard, a mouse, a joystick, a display, a touch screen display, a microphone, a speaker, and/or other input/output mechanisms. As such, the user interface 216 may, in some example embodiments, allow user control of athlete evaluation operations and/or the like. In some example embodiments in which the athlete evaluation apparatus 102 is embodied as a server, cloud computing system, or the like, aspects of the user interface 216 may be limited or the user interface 216 may not be present. In some example embodiments, one or more aspects of the user interface 216 may be implemented on a user terminal 110. Accordingly, regardless of implementation, the user interface 216 may provide input and output means to facilitate athlete evaluation in accordance with one or more example embodiments.

The communication interface 218 may include one or more interface mechanisms for enabling communication with other devices and/or networks. In some cases, the communication interface 218 may be any means such as a device or circuitry embodied in either hardware or a combination of hardware and software that is configured to receive and/or transmit data from/to a network and/or any other device or module in communication with the processing circuitry 210. By way of example, the communication interface 218 may be configured to enable the athlete evaluation apparatus 102 to communicate with the user terminal 110 via the network 100. Accordingly, the communication interface 218 may, for example, include supporting hardware and/or software for enabling communications via cable, digital subscriber line (DSL), universal serial bus (USB), Ethernet, or other methods.

In some example embodiments, the processor 212 (or the processing circuitry 210) may be embodied as, include, or otherwise control an event controller 220, profile controller 230, search controller 240 and/or rating controller 250. As such, the event controller 220, profile controller 230, search controller 240 and/or rating controller 250 may be embodied as various means, such as circuitry, hardware, a computer program product comprising computer readable program instructions stored on a computer readable medium (for example, the memory 214) and executed by a processing device (for example, the processor 212), or some combination thereof. The event controller 220, profile controller 230, search controller 240, and/or rating controller 250 may be implemented on separate apparatuses, the same apparatus, or any combination of apparatuses. The event controller 220, profile controller 230, search controller 240 and/or rating controller 250 may be capable of communication with one or more of the processor 212, memory 214, user interface 216, and communication interface 218 to access, receive, and/or send data as may be needed to perform one or more of the functionalities described herein.

The athlete evaluation apparatus 102 may comprise an event database 222, an athlete profile database 232, and/or an athletic tests database 252. Additionally or alternatively, data described herein as being stored on the event database 222, the applicant profile database 232, and/or the athletic tests database 252 may be stored on the memory 214. The event controller 220 may communicate with the event database 222 to maintain sporting event details. The profile controller 230 may communicate with the athlete profile database 232 to maintain profile related data. The search controller 240 may query the event database 222 and/or the athlete profile database 232 to enable athletic skill evaluating and/or searching functionalities described herein. The rating controller 250 may communicate with the athletic tests database 252 to access standardized athletic tests. In some example embodiments, such as those in which the athletic evaluation apparatus 102 is implemented as a distributed system, the event database 222, the athlete profile database 232, and/or athletic tests database 252 may be remote from other components of the athletic evaluation apparatus 102, and may be accessed by event controller 220, the profile controller 230, rating controller 250, respectively, via the communication interface 218.

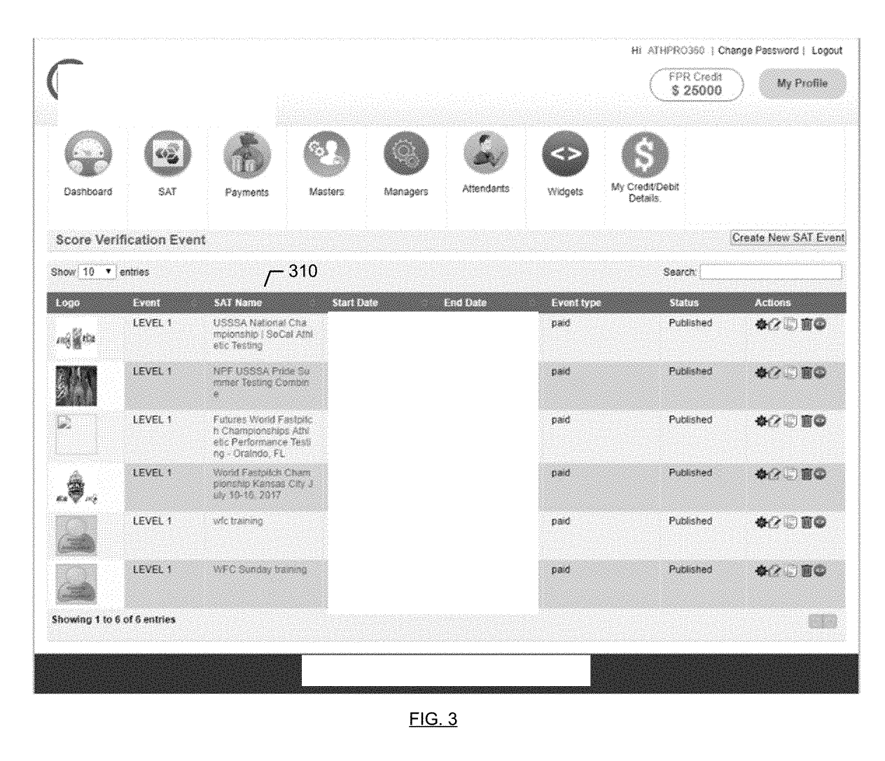

In some embodiments, the athlete evaluation apparatus 102 may be configured to provide a visual display presenting possible events for a scout to attend, such as illustrated in FIG. 3. FIG. 3 may illustrate, such as on user terminal 110 an example display of possible events for a scout to attend, such as may be useful for a scout to attend and rate attending athletes at the event. In the example depicted in FIG. 3, a user has indicated at 310 an event named USSSA National Championship. In some embodiments, as will be described in greater detail herein, a display such as the one illustrated in FIG. 3 may be used by a scout searching for an event. Additionally or alternatively, the display of FIG. 3 may be used by a user assigning or registering an athlete for an event. Upon selection of an event, such as event 110, a user may be able to access additional information regarding the event, including but not limited to, a display such as the display of FIG. 4.

In some embodiments, the athlete evaluation apparatus 102 is configured to display a roster of athletes attending the event 310, such as in the example display of FIG. 4. FIG. 4 is an example display a user (i.e., a scout and/or an athlete) may use to navigate a listing of attending athletes, and to initiate registering an athlete for the event. A display such as that of FIG. 4 may assist a user in reviewing all attending athletes. In this example, a scout may have already identified an athlete to evaluate. In area 410, the athlete evaluation apparatus 102 may provide quick information of a particular athlete, such as team name, player identification, graduation year, positions played, and/or team manager. Upon selection of a particular athlete 410, the athlete evaluation apparatus 102 may receive an indication to register a new athlete and/or associate previously registered athlete to a new event, as described in greater detail below.

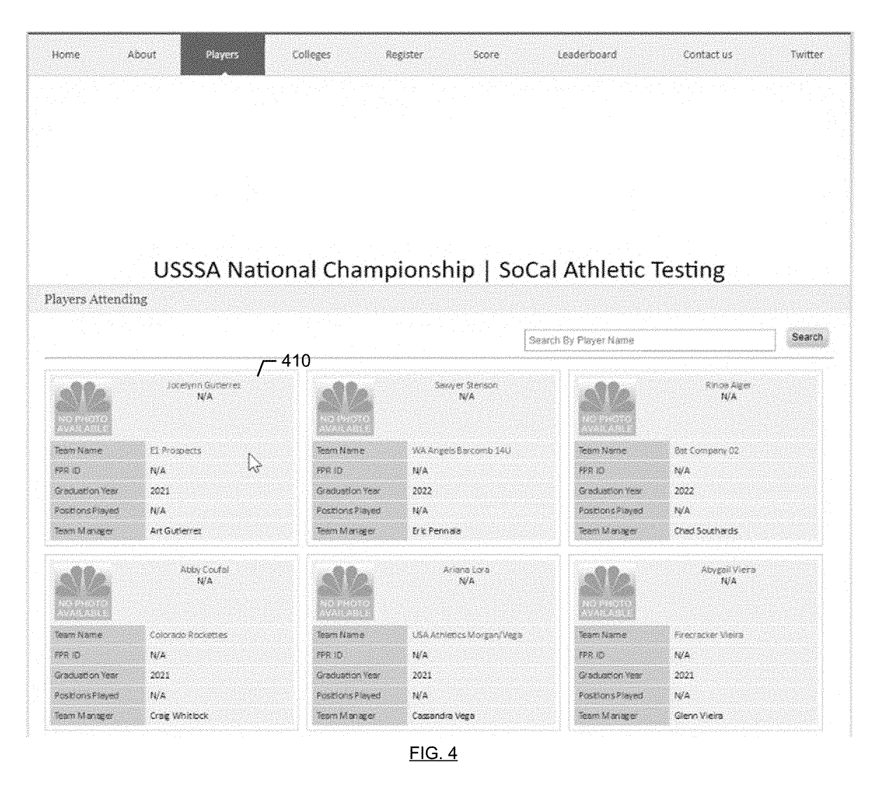

In some embodiments, athlete evaluation apparatus 102 may be configured to display an athlete's profile, such as shown in the example displays of FIGS. 5a and 5b. A player profile may display academic information and rating information for a user (i.e., an athlete and/or scout) to view. Area 510 illustrates an example display that shows a quick view of the athlete's graduation year, team information, position information, and/or grade point average. An academic summary may be displayed on the same display in area 520. In some embodiments, the academic summary area 520 displayed may include information about the athlete's school, grade point average, standardized test scores, and/or the like. Additionally or alternatively, the display may include area 530 comprising score summaries including links to videos of the athlete performing one or more athletic demonstrations. In this regard, the display of FIG. 5b may be used by scouts evaluating the player. In some embodiments, the athlete evaluation apparatus 102 may initiate registering an athlete to populate an athlete profile and/or associate an existing athlete profile with a specific event.

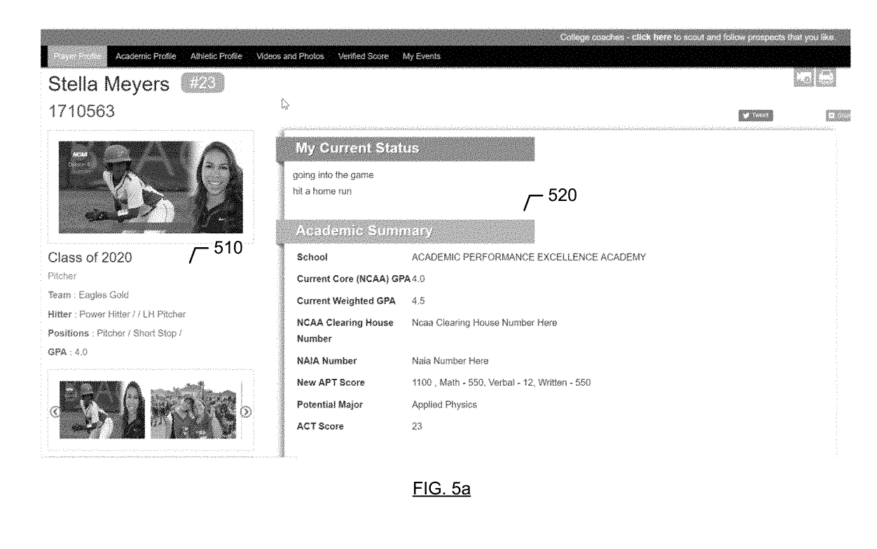

In some embodiments, the athlete evaluation apparatus 102 may be configured to register an athlete to an event. FIGS. 6 and 7 illustrate example displays that may be presented to a user (e.g., an event coordinator and/or athlete) to enable the user to register an athlete to an event, according to some example embodiments. Registration may comprise registering a new athlete unknown to the system or registering an existing athlete previously registered and thus known by the system.

In some embodiments, the athlete evaluation apparatus 102 may be configured to receive a request to register an athlete to an event. FIG. 6 is an example display that may be presented to a user by which the user (e.g., an event coordinator and/or athlete) may initiate the athlete registration process. By selecting indicator 610, a user may indicate a request to register an athlete.

In some embodiments, upon receiving an indication to register an athlete (e.g., via the display of FIG. 6), the athlete evaluation apparatus 102 may present display area 620 of the display of FIG. 6 for a user to provide player information. In area 620, a user may provide information including but not limited to the event name, event manager, player first name, player last name, player gender, player email address, player username, player password, and player height. In some embodiments, the athlete evaluation apparatus 102 may be configured to generate a unique code identifying the player on the field and an athlete identification number. The unique code is associated with the athlete identification number.

By selecting a tab 630, the user may indicate that they wish to register an existing player to an event. In response, event controller 220, or profile controller 230, may present a display such as that shown in FIG. 7.

FIG. 7 illustrates an example display for a user to provide registration information about the player for which the player is checking in to an event. In area 710, a user may enter information needed to register the player, such as, but not limited to, player's manager (e.g., skills evaluator), player height, player skill preference designation (e.g. left-handed, right-handed, both), and payment information.

It should be noted that the displays of FIGS. 6 and 7 are described with respect to registering an athlete, however, the displays may be used to modify existing registration information, athlete information, or to complete entering registration information for a player that was previously started and not completed. Displays in accordance with FIGS. 6 and 7 may provide additional searching and filtering of information to be associated with an athlete and/or event to facilitate data entry and/or identification of particular athlete and/or event.

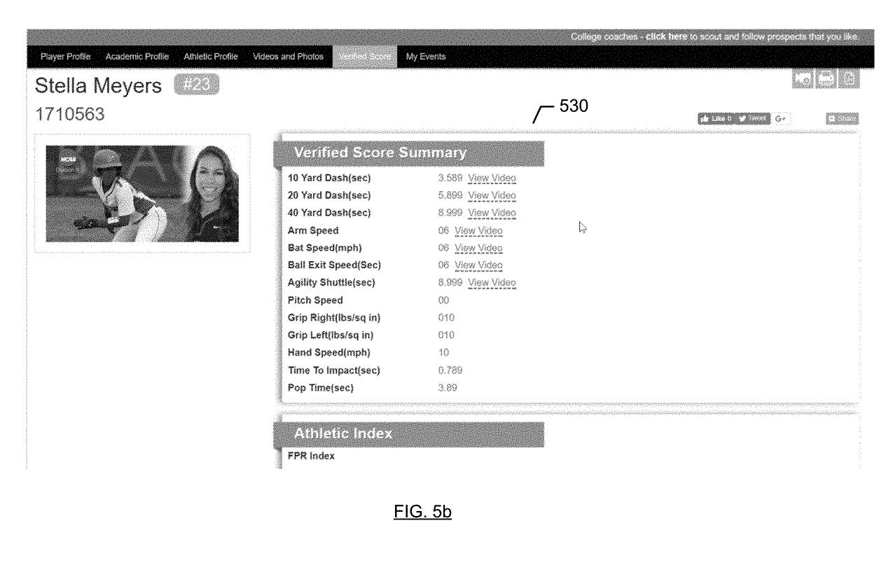

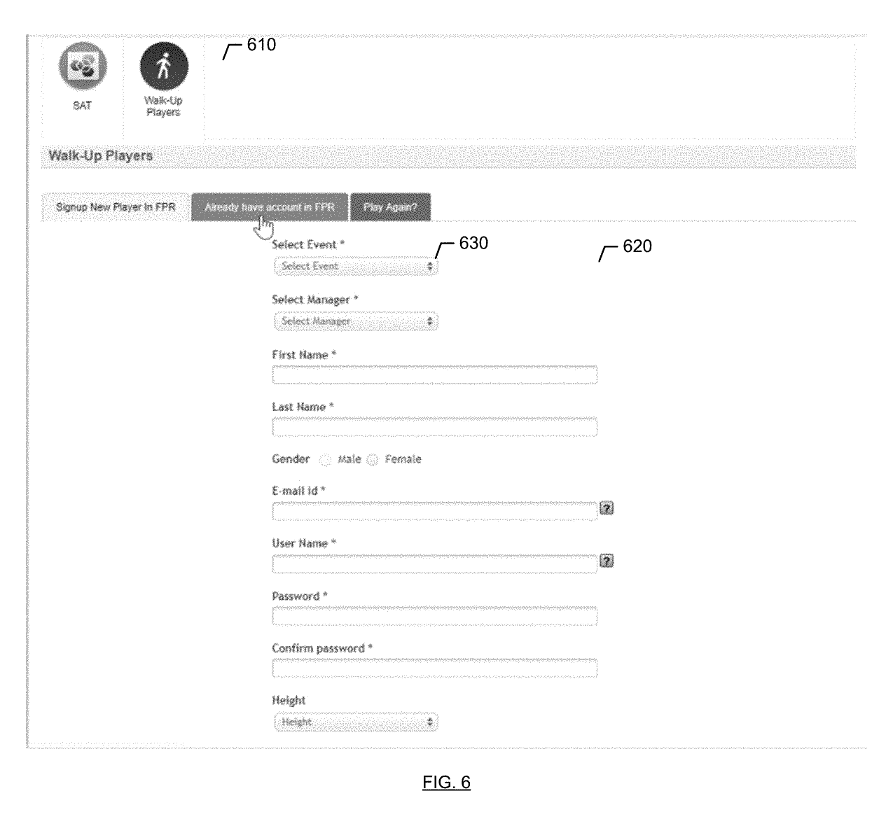

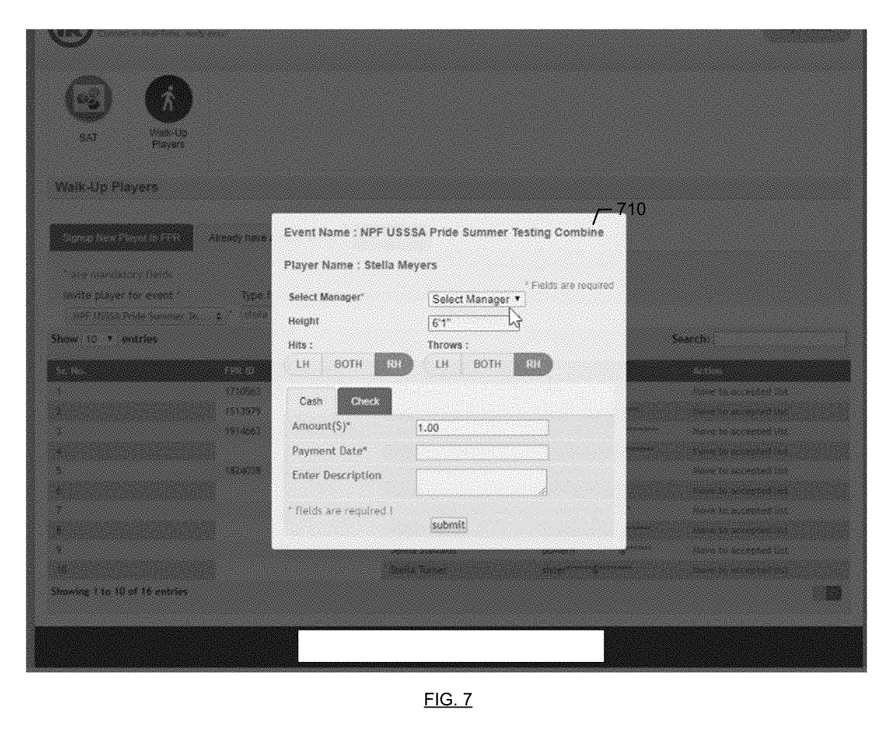

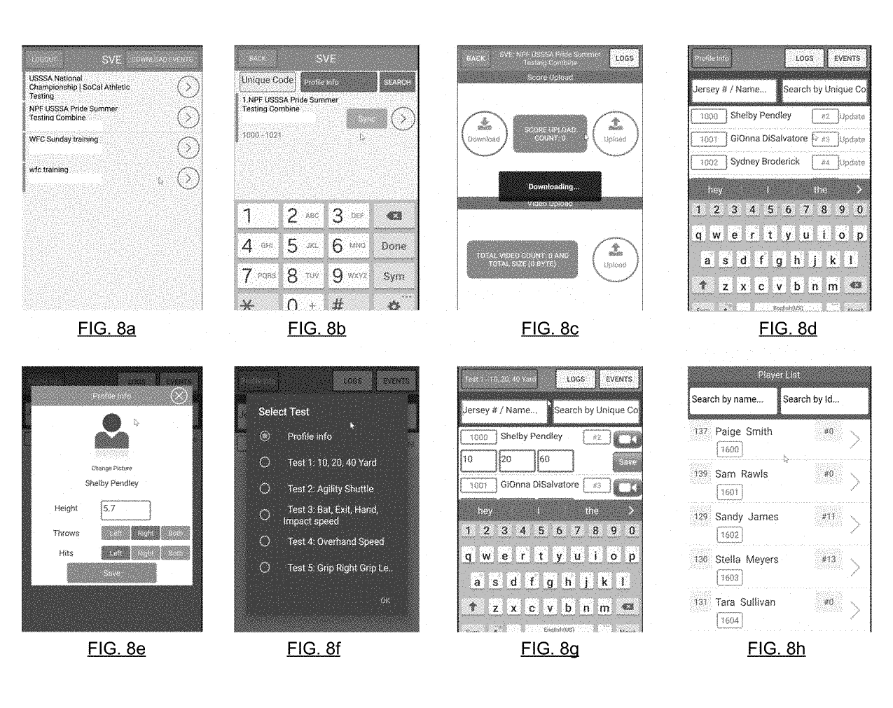

In some embodiments, the scout may rate the skills of an athlete on the field at the event using the athlete evaluation app. The scout associated with the athlete evaluation apparatus 102 must be properly logged-in to the app stored on the user terminal 110 that provides athlete assessment capability. Using defined laser testing devices, the scout may administer sports specific athletic measurement tests and input data from the tests in real-time at the event using the app. FIGS. 8a-8h show exemplary screens related to enabling the scout to rate an athlete at an event through a series of tests that are specific to the athlete's sport.

In some embodiments, the athlete evaluation apparatus 102, via the app, may be configured to enable the scout to view a list of upcoming scheduled sporting events, as depicted in FIGS. 8a-8b. Additionally or alternatively, the app may be configured to search and retrieve a particular event by a unique code identifying the event and/or event profile information. The event profile information associated with an event may include the name of the event, the unique code identifying the event, the location of the event, and/or the dates of the event. In a depicted embodiment shown in FIGS. 8c-8d, the scout may be enabled, via the app, to download and/or upload athletic measurement tests associated with the event and/or a particular athlete. The app is also configured to provide downloading and/or uploading capabilities related to videos of the athlete performing the skills measurements tests. As depicted in FIG. 8e, a user (i.e., a scout and/or an athlete) may input various physical characteristics of a player, such as height, throwing preference (i.e., right/left), and batting preference (i.e., right/left).

In some embodiments, the app may be configured to find and display a listing of standardized athletic tests related to the athlete's sport. FIG. 8f illustrates an example display of a listing of standardized tests related to the athlete's sport as well as the athlete's profile information, such as may be useful for selecting a particular test to capture the various sports related metrics. The athlete is tested and evaluated on sport-specific skills in the exact same manner, under the same conditions, and based on the exact same criteria as other athletes. The level of testing standardization provided by the app enables all athletes to be evaluated and rated consistently, thereby allowing different athletes to be appropriately compared against one another. Example methods for displaying a selected standardized test for capturing the athlete's skill metrics are described herein with reference to FIG. 8g. FIG. 8g shows a list of athletes at event. The app may also provide the ability to search and retrieve a particular athlete by the athlete's name, jersey number, and/or unique code. As described herein, the app may determine standardized athletic skill test to display based on the athlete and his or her specific athletic sport.

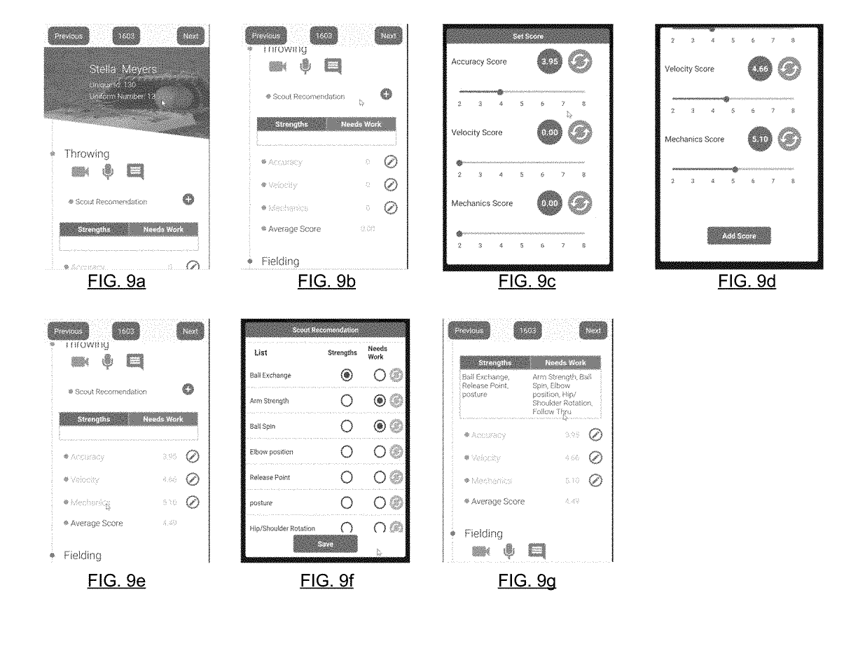

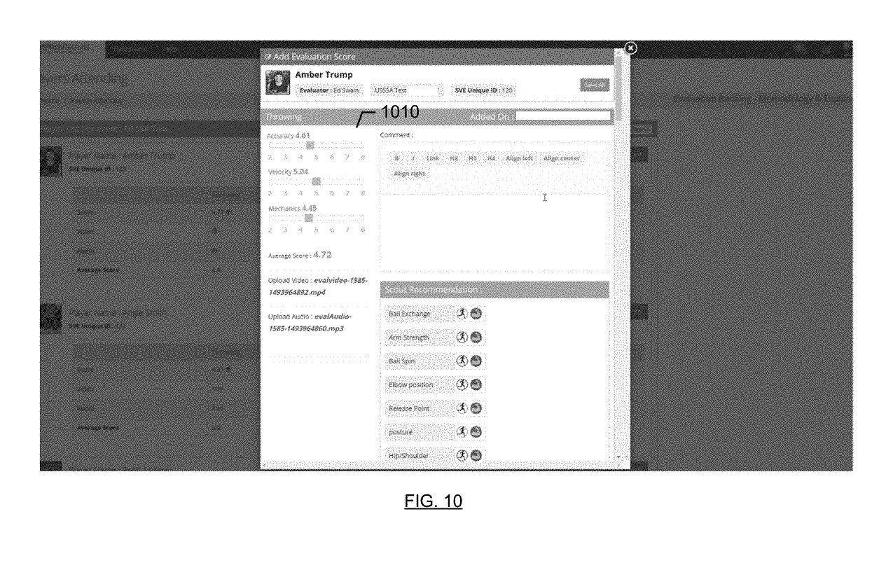

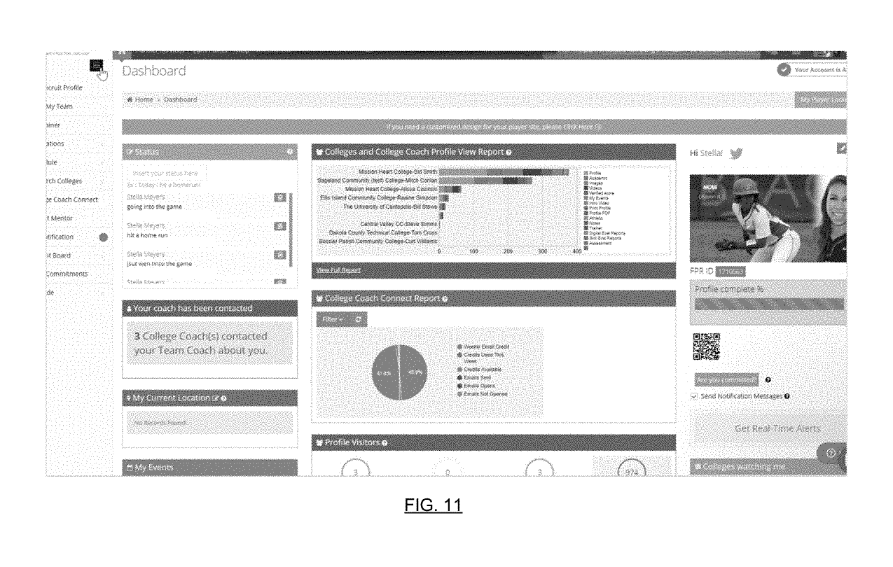

In some embodiments, the app may be configured to receive a request from a scout to display an athlete to rate. In some embodiments, the app may retrieve the requested athlete's profile and be configured to gather information, such as the athlete's sport and/or metrics gathered by other independent professional scouts. In some embodiments, the app may be configured to query, such as through the search controller 240, the athletic profile database 232 to locate a profile that is associated with the requested athlete. The app is also configured call for input related to a specific athletic test (e.g., a time for a 40-yard dash, a pitching speed, etc.) such as through the rating controller 250 which may query the athletic tests database 252 to locate an athletic test that is associated with the athlete's sport. For example, the app may locate the requested athlete, then, the app will determine the athletic tests associated with the athlete's sport, and display user input fields, such as shown in FIGS. 9a-9g to capture the user's ratings of the athlete performing the tests. The app is also configured to capture video, audio, and/or notes related to the test performance. For example, in the depicted embodiments of FIGS. 9a-9g, a scout may scroll to an athletic skill measurement such as throwing (see FIGS. 9a and 9b) and indicate (e.g., via selection of a sliding scale provided in FIG. 9c) a score. The app may also provide for a reset button to reset the score as depicted in FIGS. 9c and 9d. For example, the scout having previously entered a velocity score 4.66 with the sliding scale may reset the score to 0.00 using the reset button. In another embodiment, a scout may scroll to the athletic skill fielding (see FIG. 9e) and indicate (e.g., via selection of radio buttons provided in FIG. 9f) scoring metrics related to the scout's recommendations of skills marked as either a strength or requiring more work. In yet another embodiment, the app may summarize the selections made from the radio buttons shown in FIG. 9f and display a table as shown in FIG. 9g. Additionally or alternatively, the scout may enter text providing more information regarding the skills marked as either strengths or requiring more work. As shown in FIG. 10, the scout may also enter their evaluation score in a desktop version of the app.

In one embodiment, the system of the present invention utilizes an Athletic Index that serves as a communized metric for an athlete's athletic abilities. The process of calculating the Athletic Index will be described in further detail below. Within the context of the present invention, each athlete is placed through a specific set of defined and commonized athletic tests which may be listed for display as depicted in FIG. 8f. The Athletic Index is herein explained with respect to the sport of baseball. In order to calculate the athlete's Athletic Index, the athlete is tested on a range of baseball-related metrics. For example, the player may be tested on various baseball-related metrics including, but not limited to: at speed, hand speed, arm speed, throw velocity, grip strength, 10 yard sprint, 20 yard sprint, 40 yard sprint, and/or agility shuttle times. The Athletic Index is accordingly based on objective measurements of an athlete's performance.

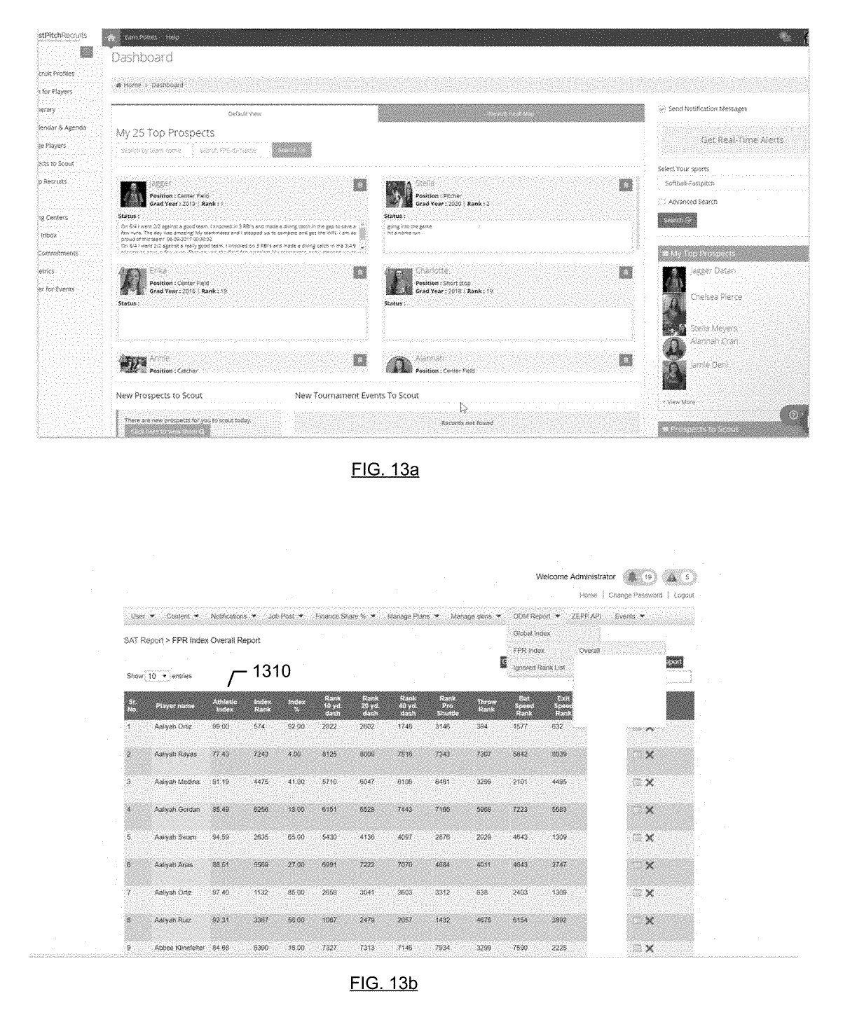

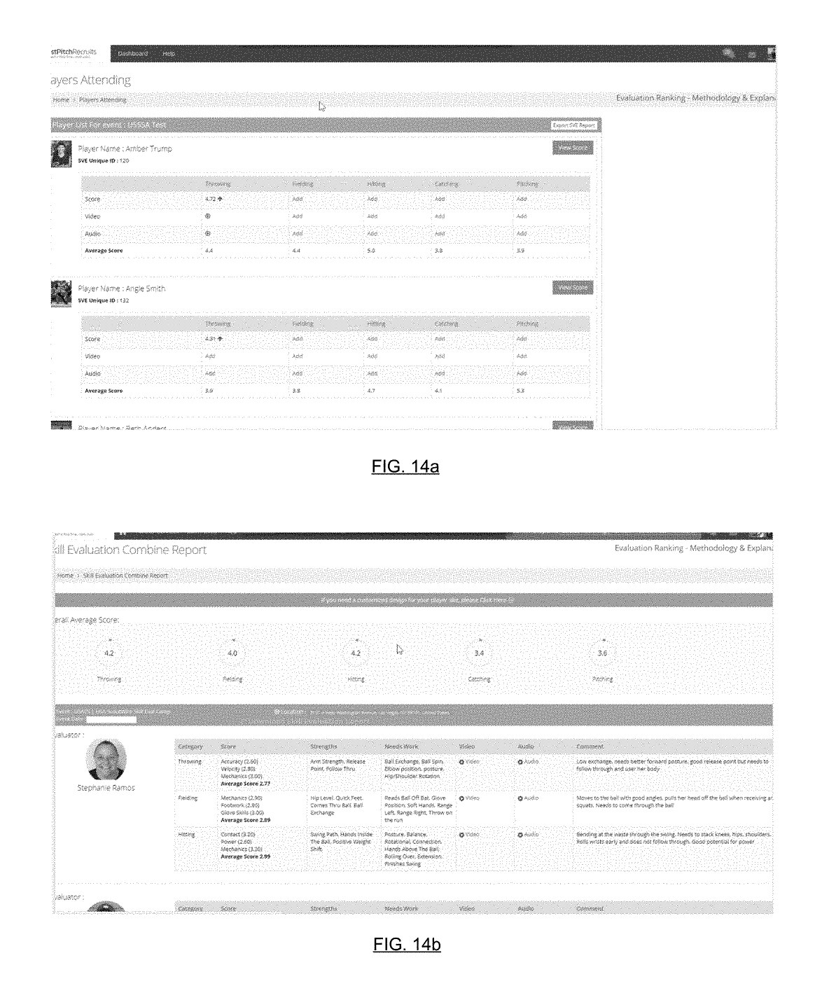

These metrics are aggregated in order to calculate the athlete's Athletic Index. The athlete's performance on these metrics is compared to the performances of other athletes at the same level. The aggregated performances of all athletes are utilized to generate a set of standards for the various metrics in which athletes may be categorized as above average, average, and below average. The Athletic Index is determined by comparing the athlete's performance in the various baseball-related metrics to the performances of other athletes in the same baseball-related metrics. As shown in area 1310 of FIG. 13b, in one embodiment of the present invention, the Athletic Index is a 0-100 score that is indicative of the athlete's standing amongst other athletes with respect to the various testing metrics. The athlete's athletic performance and the athletic performances of other athletes are stored on the athlete profile database 232 that may be accessed by coaches and other team staff who are able to utilize the data for recruiting purposes.

In addition to the Athletic Index, the system of the present invention utilizes a Skill Index. The Skill Index serves as a metric of the athlete's skills in his or her specific sport. The process of calculating the Skill Index will be described in further detail below. As with the Athletic Index, the Skill Index is herein explained with respect to the sport of baseball. The Skill Index is calculated by testing the athlete on a range of baseball-specific skills. The player may be tested on various baseball-specific skills including, but not limited to: hitting, fielding, throwing, pitching, and/or catching. The athlete is tested and evaluated on sport-specific skills in the exact same manner, under the same conditions, and based on the exact same criteria as other athletes. This level of testing standardization enables all athletes to be evaluated and rated consistently for comparison against other athletes.

In one embodiment of the present invention, the athlete's skills are evaluated and then rated by at least three independent professional scouts. The ratings provided by the independent professional scouts are averaged in order to calculate the athlete's Skill Index. In one embodiment of the present invention, each independent professional scout is able to provide a 2-8 rating for each of the athlete's sport-specific skills. The ratings provided by the independent professional scouts are then averaged to calculate the Skill Index. As shown in area 1010 of FIG. 10, the Skill Index is a 2-8 rating that is indicative of the athlete's skills in his or her specific sport. The independent professional scouts may provide further explanations and information for each rating assigned to the sport-specific skills. As with the Athletic Index, the athlete's performance in various sport-specific skills as well as the performances of other athletes in the sport-specific skills are stored on the athlete profile database 232 for access by coaches and other team staff. The Skill Index provides a third party overview of the athlete's sport-specific skills which may not necessarily be assessed by objective measurement. By including at least three independent scout's ratings, the Skill Index may provide a more robust assessment of the athlete's observed skills as compared to an index based on a single scout's ratings. For example, each scout's ratings may be varied based on the scout's particular background, experience, and vantage point for viewing the athlete's performance. By basing the Skill Index on the ratings of at least three scouts, the Skill Index may accommodate variation between individual scout's evaluations.

In one embodiment of the present invention, each skill set used to calculate the Skill Index is individually weighted. Additionally, each independent professional scout may be tasked with evaluating various aspects of each skill set. For example, with reference to the example of baseball-related skills, the skill of throwing may be broken down into several variables. Throwing may be evaluated by assessing the accuracy, power, and mechanics of the athlete's throw. These variables may be broken down even further. For example, evaluating throwing mechanics may involve the assessment of various sub-variables such as elbow position and posture.

The Athletic Index and the Skill Index are combined in order to calculate a Total Player Rating that serves as an overall player rating for the athlete. In one embodiment of the present invention, the Total Player Rating is calculated through an algorithm that takes into account both the Athletic Index and the Skill Index in order to calculate a quantifiable metric that is indicative of the athlete's overall abilities and skills. The Total Player Rating is a 0-100 rating, similar to the Skill Index.

In addition to athletic ability and sport-specific skills, various athlete physical characteristics are taken into consideration when calculating the Total Player Rating. For example, in the sport of baseball, height is a factor that may considerably affect a player's abilities and performance. Other physical characteristics such as weight and build may be taken into consideration by the algorithm when calculating the Total Player Rating.

As previously discussed, the athlete evaluation apparatus 102 provides for a database for athletes' athletic abilities and sport-specific skills. As a result, the system 101 may be utilized to perform searches for athletes based on specific athletic abilities and skills. For example, it is possible to search for athletes that satisfy a specific threshold for Athletic Index, Skill Index, or Total Player Rating. It is also possible to search for athletes that satisfy specific thresholds for various tests used when calculating the Athletic Index or Skill Index. Athletes may also be ranked by various variables such as Athletic Index, Skill Index, and Total Player Rating on a local, regional, or national level.

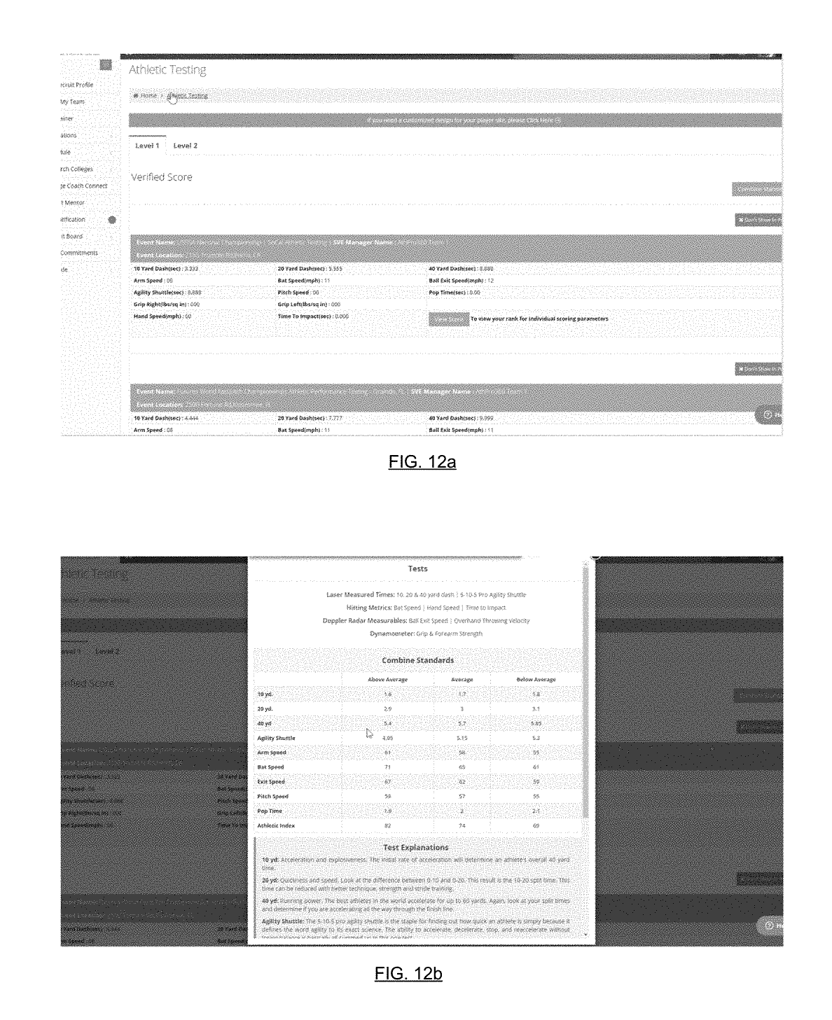

In some embodiments, the athlete evaluation apparatus 102 may include user interface 216 for displaying athlete skills assessment information to the athlete themselves and/or their coaches. FIG. 10 shows an example athlete profile that visually presents various information regarding an athlete's statistics, college view reports, and athletic testing scores. The athlete evaluation apparatus 102 may also display information regarding the athletic testing scores such as standards and explanations of test measurements as depicted in FIGS. 12a and 12b.

FIGS. 13a-14b show example views provided for display, such as via a user terminal 110. As shown in FIG. 13a, the athlete evaluation apparatus 102 provides for display a main dashboard where coaches can view top athlete prospects. In some embodiments, the athlete evaluation apparatus 102 may provide reports such an overall player ranking as depicted in FIG. 13b. Such reports generated by the athlete evaluation apparatus 102 provide for a quick view of the Athletic Index, Skill Index, and Total Player Rating of different athletes on a local, regional, or national level.

In some embodiments, the athlete evaluation apparatus 102 may be configured to perform a query for a particular player and display the player's scores as depicted in FIG. 14a. Additionally or alternatively, the athlete evaluation apparatus 102 may be configured to generate a more detailed report of the athlete's evaluation based on the evaluator/scout (see FIG. 14b). Such report generation enables both coach and athlete to assess the athlete's skills, improvement areas, and likelihood of launching the athlete's athletic career.

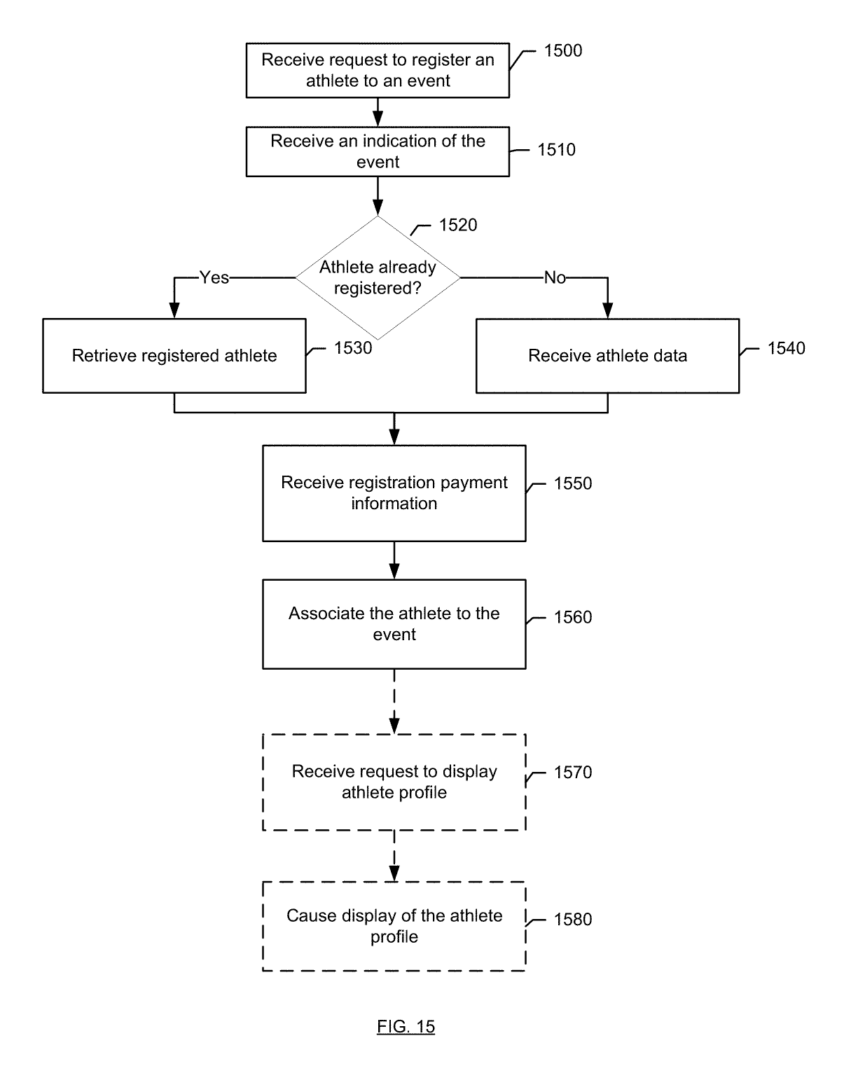

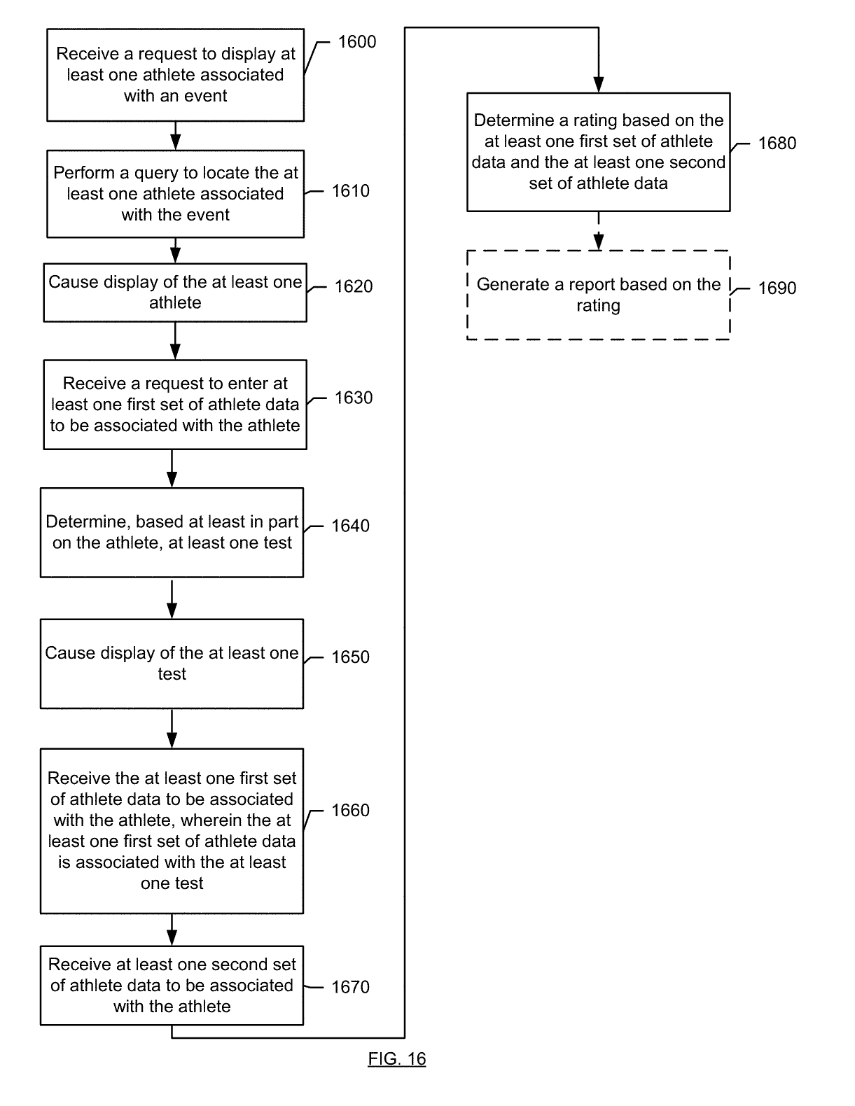

FIGS. 15 and 16 are flowcharts of various operations of the athletic evaluation apparatus 102 according to some embodiments. Operations illustrated in FIGS. 15 and 16 may be performed by an athlete evaluation apparatus 102 and, more particularly, may be performed by, with the assistance of, and/or under the control of one or more of the processing circuitry 210, processor 212, memory 214, user interface 216, communication interface 218, event controller 220, profile controller 230, search controller 240, and/or rating controller 250. For example, some operations of FIGS. 15 and 16 may comprise receiving an indication, selection, or some other user input. In some embodiments such an input may be provided by a user via user terminal 110 and communicated to the athlete evaluation apparatus 102 via the communication interface 218.

FIG. 15 illustrates an example method for registering an athlete according to example embodiments described herein. Operation 1500 may comprise receiving a request to register an athlete to an event. The processor 212, user interface 216, communication interface 218, and/or event controller 220 may, for example, execute operation 1500.

Operation 1510 may comprise receiving an indication of an event. In some embodiments, the indication of an event may be at least one of acquired or targeted, wherein acquired relates to the desired athlete having performed at the event before and/or already registered with the system, and wherein targeted relates to the athlete being able to perform the athletic skills being assessed at the event. The processor 212, user interface 216, communication interface 218, and/or event controller 220 may, for example, execute operation 310.

In some embodiments, operation 1530 may comprise determining whether the desired athlete is already registered with the system. The processor 212, user interface 216, communication interface 218, search controller 240, profile controller 230, event database 222, and/or athlete profile database 232 may, for example, provide means for checking against the event database 222 and/or athlete profile database 232 to determine whether the athlete is known to the system. In this example embodiment, input boxes are available for an athlete name and/or athlete identification, which when entered may be checked against the event database 222 and/or athlete profile database 232. If the processor 212, search controller 240, profile controller 230 cannot retrieve the desired athlete, a transmission indicating this fact may be returned to the user terminal 110, which in turn may require that the user to re-enter the desired athlete's information such as name and/or identification or generate a new athlete profile via a registration process. The registration process may comprise requesting athlete data (block 1540). Athlete data may comprise information such as athlete first name, athlete last name, manager name, gender, email address, athlete username, athlete password, and/or height. In some embodiments, the operation 1550 may comprise receiving registration payment information. Acceptable payment information may comprise cash and/or checking information. Upon receiving payment information, the athlete is associated with the event (block 1560). The processor 212, user interface 216, event database 222, athlete profile database 232, and/or event controller 220 may, for example, execute operation 1560.

In an instance in which the athlete is already registered and/or has already created an athlete profile, the desired athlete's profile is retrieved from athlete profile database 232 (block 1530), and registration payment information may be received for the event (block 1550). Upon receiving payment information, the athlete is associated with the event (block 1560). The processor 212, user interface 216, event database 222, athlete profile database 232, and/or event controller 220 may, for example, execute operation 1560.

In some embodiments, operation 1570 may comprise receiving a request to display the athlete's profile (block 1570). The processor 212, user interface 216, event database 222, athlete profile database 232, profile controller 230, and/or event controller 220 may, for example, execute operation 1570.

In some embodiments, operation 1580 may comprise causing to display the athlete's profile (block 1580). The processor 212, user interface 216, event database 222, athlete profile database 232, profile controller 230, and/or event controller 220 may, for example, execute operation 1580.

Continuing on, FIG. 16 is a flowchart illustrating a method for entering and evaluating an athlete's athletic ability and physical skill set. The method further includes generating reports to project the athlete's potential in an athletic career as well as rank the athlete amongst other athletes in the same level.

In some embodiments, operation 1600 may comprise receiving a request to display at least one athlete associated with an event. The processor 212, user interface 216, athlete profile database 232, event database 222, search controller 240, and/or profile controller 230 may, for example, provide means for operation 1600. The event may be associated with a sporting event, for example, in which student athletes are assessed and scored based on their athletic ability and physical skill set. In some embodiments, the app provides a listing of events. Data associated with the list of events may be downloaded to the app at any time using communication interface 218.

In some embodiments, operation 1610 may comprise performing a query to locate a particular athlete associated with an event. The processor 212, event database 222, athlete profile database 232, search controller 240, event controller 220, and/or profile controller 230 may, for example, execute operation 1610. In some embodiments, the query comprises at least one of the following: athlete's name, the unique id generated by the system to identify the athlete on the field, or athlete's jersey number.

In some embodiments, operation 1620 may comprise causing display of the athlete, such as, for example, by use of processor 212, event database 222, athlete profile database 232, search controller 240, event controller 220, and/or profile controller 230.

In some embodiments, operation 1630 may comprise receiving a request to enter at least one first set of data to be associated with the athlete. For example, the first set of data may include specific athletic measurement tests using defined laser testing devices. The athlete is put through a specific set of defined athletic tests specific to the athlete's sport in which the results from the tests are recorded by a scout to the app, such as by being input into the user terminal 110. In some embodiments, an Athletic Index that serves as a measure of the athlete's athletic abilities is calculated based on the results of these tests. Additionally, the scout may be able to upload video taken of the user performing such tests via the app. All data captured may be uploaded to the cloud so as to update the event database 222, athlete profile database 232, and/or athletic tests database 252. The processor 212, event database 222, athlete profile database 232, search controller 240, event controller 220, and/or profile controller 230 may, for example, execute operation 1630.

In some embodiments, operation 1640 may comprise determining, based at least in part on the user, at least one standardized test. The processor 212, event database 222, athlete profile database 232, athletic tests database 252, search controller 240, event controller 220, rating controller 250, and/or profile controller 230 may, for example, execute operation 1640.

In some embodiments, operation 1650 may comprise causing display of the at least one standardized test, such as, for example, by use of processor 212, event database 222, athlete profile database 232, athletic tests database 252, search controller 240, event controller 220, rating controller 250, and/or profile controller 230.

According to some embodiments, operation 1660 may comprise receiving the at least one first set of user data to be associated with the athlete, wherein the at least one first set of data is associated with the at least one test. The processor 212, event database 222, athlete profile database 232, athletic tests database 252, search controller 240, event controller 220, rating controller 250, and/or profile controller 230, may, for example, provide means for performing operation 1660.

In some embodiments, operation 1670 may comprise receiving at least one second set of user data to be associated with the athlete. The processor 212, event database 222, athlete profile database 232, athletic tests database 252, search controller 240, event controller 220, rating controller 250, and/or profile controller 230, may, for example, execute operation 1670. In some embodiments, the second set of data is provided by an independent professional scout and based on test results associated with a defined set of skills of the athlete that are specific to his or her sport. The processor 212, user interface 216, rating controller 250, and/or athletic tests database 252, may, for example, provide the tests and/or evaluations the scout uses. Athlete testing is completely standardized and all athletes are assessed based on the exact same criteria. The ratings provided by the scout are then averaged in order to calculate a Skill Index that serves as a measure of the athlete's skills in the specific sport. The processor 212, user interface 216, rating controller 250, and/or athletic tests database 252, may, for example, provide such calculations.

Operation 1680 may comprise determining a rating based on the at least one first set of data and the at least second set of data. The processor 212, event database 222, athlete profile database 232, athletic tests database 252, search controller 240, event controller 220, rating controller 250, and/or profile controller 230, may, for example, execute operation 1680. The first set of data (e.g. athlete's athletic ability) is used to calculate the Athlete Index, whereas the second set of data (e.g. ratings from the independent professional scouts) is used to calculate the Skill Index that serves as a measure of the athlete's skills in his or her specific sport. The Athletic Index and the Skill Index are then combined in order to calculate a Total Player Rating that serves as an overall athlete rating taking into account the athlete's athletic abilities and the athlete's skills specific to her or her sport. The processor 212, user interface 216, rating controller 250, and/or athletic tests database 252, may, for example, provide said calculations.

Optionally and in some embodiments, operation 1690 may comprise generating a report based on the Total Player Rating. The processor 212, event database 222, athlete profile database 232, athletic tests database 252, search controller 240, event controller 220, rating controller 250, and/or profile controller 230, may, for example, execute operation 1690. In some embodiments, the generated report may be displayed and configured to provide additional information such as a listing of top athletes based on one or more criteria.

FIGS. 15 and 16 each illustrate a flowchart of a system, method, and computer program product according to some example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214) storing instructions executable by a processor in the computing device (for example, by the processor 212). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, an athlete evaluation apparatus 102 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, an athlete evaluation apparatus 102 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a request to display at least one user profile associated with an event;
performing a query to locate the at least one user profile associated with the event;
presenting for display via a user terminal, the at least one user profile;
receiving a request to enter at least one first set of user data to be associated with the user;
determining, based at least in part on the at least one user profile, at least one test;
presenting for display via the user terminal, the at least one test;
receiving the at least one first set of user data to be associated with the at least one user profile, wherein the at least one first set of user data is associated with the at least one test;
receiving at least one second set of user data to be associated with the user profile; and
determining a rating based on the at least one first set of user data and the at least one second set of user data.

2. The method of claim 1, wherein the at least first set of user data comprises one or more results from one or more tests related to an athlete's athletic abilities in a particular sport.

3. The method of claim 1, wherein the at least second set of user data comprises one or more reviews related to an athlete's athletic skills in a particular sport.

4. The method of claim 3, wherein the at least second set of user date comprises at least three reviews related to the athlete's athletic skills in the particular sport.

5. The method of claim 1 further comprising:
generating at least one report based on the rating; and
presenting for display via the user terminal, the at least one report.

6. The method of claim 1 further comprising:
recording at least one video of the user performing the at least one test; and
associating the at least one video with the at least one user profile.

7. The method of claim 1 further comprising:
aggregating test performances of a plurality of user profiles; and
categorizing ones of the plurality of user profiles as above average, average, and below average in athletic performance.

8. An apparatus comprising at least one processor and at least one non-transitory memory including computer program code, the at least one non-transitory memory and the computer program code configured to, with the at least one processor, cause the apparatus at least to:
receive a request to display at least one user profile associated with an event;
perform a query to locate the at least one user profile associated with the event;
present for display via a user terminal, the at least one user profile;
receive a request to enter at least one first set of user data to be associated with the user;
determine, based at least in part on the at least one user profile, at least one test;
present for display via the user terminal, the at least one test;
receive the at least one first set of user data to be associated with the at least one user profile, wherein the at least one first set of user data is associated with the at least one test;
receive at least one second set of user data to be associated with the user profile; and
determine a rating based on the at least one first set of user data and the at least one second set of user data.

9. The apparatus of claim 8, wherein the at least first set of user data comprises one or more results from one or more tests related to an athlete's athletic abilities in a particular sport.

10. The apparatus of claim 8, wherein the at least second set of user data comprises one or more reviews related to an athlete's athletic skills in a particular sport.

11. The apparatus of claim 8, wherein the at least one processor is further configured to:
generate at least one report based on the rating; and
present for display via the user terminal, the at least one report.

12. The apparatus of claim 8, wherein the at least one processor is further configured to:
record at least one video of the user performing the at least one test; and
associate the at least one video with the at least one user profile.

13. The apparatus of claim 8, wherein the at least one processor is further configured to:
aggregate test performances of a plurality of users; and
categorize ones of the plurality of user profiles as above average, average, and below average in athletic performance.

14. A computer program product comprising a non-transitory computer readable medium having program code portions means stored thereon, the program code portions being a computer readable medium and configured when said program product is run on a computer or network device, to:
receive a request to display at least one user profile associated with an event;
perform a query to locate the at least one user profile associated with the event;
present for display via a user terminal, the at least one user profile;
receive a request to enter at least one first set of user data to be associated with the user;
determine, based at least in part on the at least one user profile, at least one test;
present for display via the user terminal, the at least one test;
receive the at least one first set of user data to be associated with the at least one user profile, wherein the at least one first set of user data is associated with the at least one test;
receive at least one second set of user data to be associated with the user profile; and
determine a rating based on the at least one first set of user data and the at least one second set of user data.

15. The computer program product of claim 14, wherein the at least first set of user data comprises one or more results from one or more tests related to an athlete's athletic abilities in a particular sport.

16. The computer program product of claim 14, wherein the at least second set of user data comprises one or more reviews related to an athlete's athletic skills in a particular sport.

17. The computer program product of claim 14, wherein the at least second set of user date comprises at least three reviews related to the athlete's athletic skills in the particular sport.

18. The computer program product of claim 14, wherein the program code portions are further configured to:
generate at least one report based on the rating; and
present for display via the user terminal, the at least one report.

19. The computer program product of claim 14, wherein the program code portions are further configured to:
aggregate test performances of a plurality of users; and
categorize ones of the plurality of user profiles as above average, average, and below average in athletic performance.

20. The computer program product of claim 14, wherein the program code portions are further configured to:
receive registration payment information; and
associate the user profile to an event.
